(19) United States
(12) Patent Application Publication
(10) Pub. No.: US 2025/0262872 A1
(43) Pub. Date: Aug. 21, 2025

(54) METHOD FOR SINGLE HANDEDLY LOADING A WIDE FORMAT WEB IN A PRINTER

(71) Applicant: CANON KABUSHIKI KAISHA, Tokyo (JP)

(72) Inventor: Marcus H.G.W. Hees, Echt (NL)

(21) Appl. No.: 19/057,623

(22) Filed: Feb. 19, 2025

(30) Foreign Application Priority Data
Feb. 19, 2024 (EP) 24158408.5

(51) Int. Cl. B41J 11/00; B41J 3/46; B41J 15/04; B41J 15/22

(52) U.S. Cl. CPC B41J 11/0085; B41J 3/46; B41J 11/001; B41J 15/048; B41J 15/22

(57) ABSTRACT

A simple method is provided that allows an operator to single-handedly load a web of wide format print media on a printer. The printer includes an endless transport belt extending over a plurality of independently controllable suction chambers positioned besides one another on an upstream side of the belt in a width direction of the belt. The width direction is perpendicular to a transport direction of the belt. The method includes applying a negative pressure to a selected one of the suction chambers, placing a portion of the web over the selected suction chamber, so that the portion is held in place on the belt by the negative pressure in the selected suction chamber, repeating the previous steps for positioning remaining portions of the web over respective other suction chambers, and driving the belt so that the web moves with the belt in the transport direction.

### CROSS-REFERENCE TO RELATED APPLICATIONS

This application claims priority from European Patent Application No. 24158408.5 filed on Feb. 19, 2024, which is incorporated by reference herein in its entirety.

### BACKGROUND OF THE DISCLOSURE

### Field of the Disclosure

The disclosure relates to a method of loading a web of print medium in a roll printer and a roll printer configured for performing said method.

### Description of Background Art

Wide format roll printers apply print media provided in roll form. The print media may in certain cases have widths of over 3 meters. The print medium is provided on an input roller. During printing, the print medium extends from the input roller over a medium support surface opposite a printing assembly to an output roller where the print medium is rewound. Different types of output stations may be applied as well. The medium support surface is commonly higher than the input roller, so that when loading a new print medium, its leading edge has to be brought up to the medium support surface against the direction of gravity. When the print media is very wide, a single operator generally has difficulty performing the loading. It is known to form the medium support surface of an endless transport belt, which extends over a suction box, so that the print medium can be adhered to the belt by means of a negative pressure applied via the suction box. This may result in a so-called hybrid printer, which can be used to print on both rigid substrates as well as print media provided in roll form. The top surface of the belt therein forms the medium support surface. It is additionally known to provide loading aids to raise the leading edge of a new web up to the medium support surface, as for example known from U.S. Pat. No. 10,654,297 B2.

### SUMMARY OF THE DISCLOSURE

It is an aspect of the disclosure to provide an efficient method of loading a wide format web onto a printer, preferably in a simple manner which minimizes the addition of components and/or costs to the printer.

The present disclosure is directed to a method of loading a web of print medium in a roll printer and to a wide format printer.

The printer includes an endless transport belt extending over a plurality of independently controllable suction chambers positioned besides one another in a width direction of the belt and provided on an upstream side of the belt, which width direction is perpendicular to a transport direction of the belt. The method includes the steps of: applying a negative pressure to a selected one of the suction chambers; placing a portion of the web over the selected suction chamber, so that the portion is held in place on the belt by the negative pressure in the selected suction chamber; repeating the previous step for positioning remaining portions of the web over respective other suction chambers; and driving the belt so that the web moves with the belt in the transport direction.

It is the insight of the inventor that an operator may single handedly load a wide format print medium from a roll by using the suction chambers to iteratively and cumulatively hold portions of the web brought up to the belt in place on the belt. This allows the operator to move along the full width of the print medium and bring it up to the belt in steps. When the substantially entire width of the leading portion of the web has been brought up to the belt and is being held there by the negative pressure(s) in the suction chambers, the belt is driven so that the leading portion of the web on the belt moves forward towards the printing assembly. Thus, a single operator can load a wide format web by her or himself. The method is further advantageous as the suction chambers may already have been implemented in the printer, specifically when the printer is a hybrid printer supporting so-called multilane printing, wherein multiple substrates can be transported in parallel on the belt. Additional components are then not required or their number is minimized, resulting in a simple, compact, and low cost system. Thereby the aspect of the present disclosure has been achieved.

More specific optional features of the disclosure are indicated in the dependent claims.

In an embodiment, the step of placing follows the step of applying the negative pressure for each selected suction chamber. Each respective suction chamber is first provided with a negative pressure before the respective portion of the web is placed over it. This allows the operator to use all hands for loading the web.

In an embodiment, the steps are repeated, so that the web becomes held by the respective suction chambers over its substantially full width. When all portion of the web are positioned over their respective suction chambers, the web is entirely held by the suction chambers.

In an embodiment, each suction chamber is consecutively provided with a respective portion of the web. When printing a print medium with the maximum allowable width for the printer, all suction chambers are utilized in the loading process. For narrower print media, only a subset of the suction chambers may be applied, each of which is then utilized for loading said web. Each of the suction chambers over which the print medium will pass during printing is provided with a negative pressure. Negative pressure is herein defined with respect to atmospheric pressure, as any pressure substantially lower than the ambient pressure at the printer. The web is brought up to cover one suction chamber after the other. Thus, the operator can load the web in steps. Negative pressure is herein

In an embodiment, the belt is stationary until the step of driving the belt.

In an embodiment, substantially no negative pressure is applied to suction chambers not covered by a respective portion until a suction chamber has been selected for positioning a respective portion of the web. In their initial states before loading commences, the suction chambers are preferably not in fluid connection to a suction source. Since the suction chambers are open towards the belt, which itself is air permeable, the suction chambers initially are at atmospheric pressure. When negative pressure is first applied to a suction chamber not covered yet by a portion of the web, the negative pressure may be smaller as compared to when a portion of the web covers said suction chamber due to the greater air inflow into the suction chamber in the first mentioned state. The application of a negative pressure is herein defined as a suction chamber being in fluid connection to an active suction source. In a basic example, this is controlled by the opening and/or closing of valves in the lines between the suction chambers and the respective suction source(s). When a suction chamber has been selected, the respective valve is opened, so that air is drawn in through the suction chamber towards the suction source.

In an embodiment, initially substantially no negative pressure is applied to any of the suction chambers, and the method further includes the steps of applying a negative pressure to a suction chamber different from the suction chamber over which previously a portion of the web has been positioned. As previously indicated, initially all suction chambers are preferably atmospheric pressure, except possibly in the cases wherein the width of the print medium is so small that only a subset of the suction chambers is required for loading the print medium. In at least one step, a negative pressure is applied to a suction chamber in between two separate steps of positioning a portion of the web on the belt over a suction chamber. A negative pressure is applied to a first suction chamber, followed by adhering the corresponding portion of the web over said first suction chamber. After that a different, second suction chamber is provided with a negative pressure, preferably which second pressure chamber is next to the first suction chamber. A different portion of the web is then brought up to the second suction chamber. This may be repeated until all portions of the web are adhered onto the belt over a corresponding suction chamber. Every newly selected suction chamber, with the exception of the first, preferably borders on the side of a suction chamber already provided at a negative pressure.

In an embodiment, the belt has a width of at least 3 meters. The printer is a wide format printer configured to process a single print medium with a width exceeding 3 meters. In another embodiment, the web has a width of at least 2 meters, preferably at least 2.5 meters, and very preferably at least 3 meters.

In an embodiment, the web is provided in roll form on an input roller positioned below and on the upstream side of the belt. The printer in its roll printing mode is provided with an input roller which is configured to hold a roll of print medium. Below herein is defined as the highest point on the roll being lower than the highest point on the belt. The input roller is below the medium support surface of the belt. When viewed from above, the input roller is preferably adjacent the upstream end of the belt, where the print medium first contacts the belt.

The present disclosure further relates to a wide format roll printer including: an input roller; an endless transport belt supported on a plurality of support rollers and defining a medium support area positioned above the input roller during use, wherein the plurality of support rollers includes an upstream support roller positioned on the side of the belt near the input roller; a plurality of suction chambers positioned adjacent to the upstream support roller and provided besides one another in a width direction perpendicular to a transport direction of the belt; a user interface configured for: consecutively selecting and indicating each one of the suction chambers for applying a negative pressure to said the selected suction chambers, such that a portion of the web can be adhered to the belt at the selected suction chambers.

The user interface displays a graphical representation of the different suction chambers, and preferably of their respective states, specifically whether or not a suction chamber is in fluid connection to a suction source. A suction chamber can be selected either by an operator via inputting the selection via the user interface and/or by a controller which selects a suction chamber, based on a predetermined order or algorithm (which may vary per print media type). In either case, the user interface receives a selection signal, which triggers the user interface to select the corresponding graphical representation of the respective suction chamber and indicate this selection on the user interface. This may be done by changing the appearance of the corresponding graphical representation of the respective suction chamber, for example by changing, its shape, color, or other forms of highlighting or marking. The controller further connects the respective suction chamber to its suction source, for example by opening a corresponding valve. This allows the operator to bring a portion of the web up to the belt at the respective suction chamber. After placing said portion over the suction chamber, the negative pressure adheres it to the belt, so that the portion is held in place. This allows a different suction chamber to selected on the user interface, so that the operator can adhere a different portion of the web to said suction chamber. This allows a single operator to load a wide format web. Preferably, the printer may be configured to perform any embodiment of the above-described method.

In an embodiment, the user interface is further configured for initiating driving the belt for moving the web held onto the belt, so that the web moves with the belt. Once held by the belt, the belt can be activated to move, so that the web moves it. The web is thus pulled further onto the belt.

In an embodiment, the printer further includes a controller configured to: when operating in a multi-lane printing mode control the transport belt to transport multiple individual substrates parallel to one another on the belt, wherein the controller controls to apply a negative pressure to the suction chambers in correspondence to the coverage of substrates over the suction chambers; and when operating in a roll printing mode to configure the user interface for selecting and indicating each one of the suction chambers for loading a new web.

The printer is a so-called hybrid printer configured to transport both webs and individual substrates. For web printing, the printer operates in a roll printing mode, wherein the web is unwound from the input roller. In this mode, when a new web is to be loaded, the controller configures the user interface to allow the operator to load a new web by the above-described steps. The printer can also be configured to print on substrates such as sheets, panes, panels, cardboard, rigid substrates, etc. Therein, the printer may be configured to operate in a multilane printing mode, wherein multiple substrates are provided besides one another on the belt in the width direction of the belt. The different substrates form parallel lanes on the belt. The lanes are defined by the suction chambers, wherein a lane has a width and lateral position of one or more suction chambers. When a lane or portion thereof is not used, a suction chamber is temporarily uncovered, and then may be disconnected from the suction source. The separate suction chambers can thus be applied for both web loading as well multilane printing.

Further scope of applicability of the present disclosure will become apparent from the detailed description given hereinafter. However, it should be understood that the detailed description and specific examples, while indicating preferred embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure.

FIG. 1 is a schematic perspective view of a printing system according to the present disclosure in a first printing mode;

FIG. 2 is a schematic perspective view of the printing system in FIG. 1 in a second printing mode;

FIGS. 3 to 9 schematically illustrate top down views of the printer in FIG. 2 during various steps of loading a new web on a belt of the printer;

FIGS. 10 to 11 schematically illustrate front views of a user interface of the printer in FIG. 2 during various steps of loading a new web on a belt of the printer in FIG. 2;

FIGS. 12, 14, and 16 schematically illustrate top down views of a further embodiment of the printer in FIG. 2 during various steps of a further embodiment of a method for loading a new web on a belt of the printer.

FIGS. 13, 15, and 17 schematically illustrate front views of a user interface of the printer in FIG. 12 during various steps of the further embodiment of the method for loading a new web on a belt of the printer in FIG. 2.

### DETAILED DESCRIPTION OF THE EMBODIMENTS

The present disclosure will now be described with reference to the accompanying drawings, wherein the same reference numerals have been used to identify the same or similar elements throughout the several views.

### Printing System

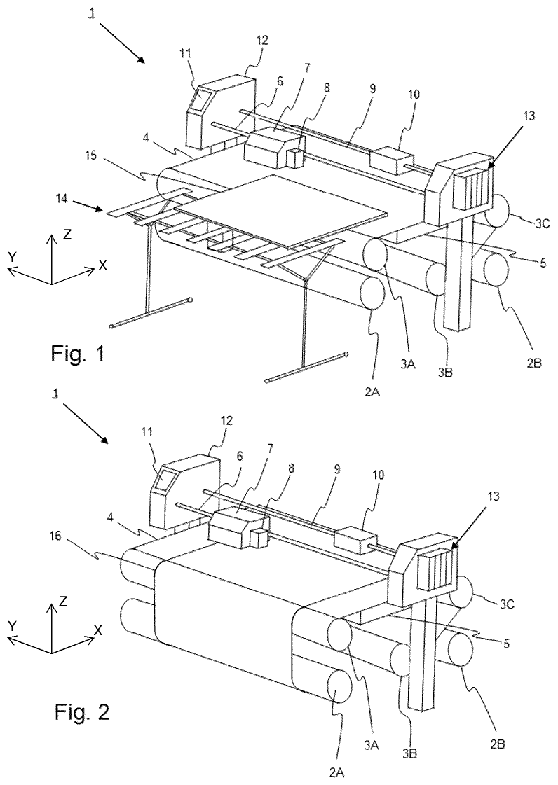

FIG. 1 shows a wide format inkjet printer 1. The wide-format printer 1 includes an inkjet printing assembly 7 for printing on a print medium 15. The print medium 15 in FIG. 1 is a relatively rigid substrate, such as a panel. The print medium 15 is supplied from a media input unit 14, which may be configured for storing a plurality of such print media 15 and supplying these to the printer 1. The printer 1 includes transport means for receiving and transporting the print medium 15 along the inkjet printing assembly 7. In FIG. 1, the transport means includes an endless transport belt 4 supported on a plurality of support rollers 3A, 3B, 3C. At least one of the support rollers 3A, 3B, 3C is provided with driving means for moving the belt 4. Additionally, one or more one of the support rollers 3A, 3B, 3C may be configured to be moved and/or tilted to adjust and control the lateral position of the belt 4. The inkjet printing assembly 7 may be provided with a sensor 8, such as a CCD camera, to determine the relative position of the belt 4 and/or the print medium 15. Data from said sensor 8 may be applied to control the position of the belt 4 and/or the print medium 15. The belt 4 is further provided with through-holes and a suction box 5 in connection with a suction source (not shown), such that a negative pressure may be applied to the print medium 15 via the through-holes in the belt 4. The negative pressure adheres the print medium 15 flatly to the belt 4 and prevents displacement of the print medium 15 with respect to the belt 4. Due to this holding, the belt 4 is able to transport the print medium 15. It will be appreciated that other suitable transport means, such as rollers, steppers, etc., may alternatively be applied. The print medium 15 may be transported stepwise and/or in continuous movement.

The inkjet printing assembly 7 is configured to translate along a first guide beam 6 in a scanning direction. The scanning direction is perpendicular to the direction in which the print medium is transported by the belt 4. The inkjet printing assembly 7 holds a plurality of print heads (not shown), which are configured to jet a plurality of different marking materials (different colors of ink, primers, coatings, etc.) on the print medium 15. Each marking material for use in the printing assembly 7 is stored in one of a plurality of containers arranged in fluid connection with the respective print heads for supplying marking material to said print heads to print an image on the print medium 15.

The ejection of the marking material from the print heads is performed in accordance with data provided in the respective print job. The timing by which the droplets of marking material are released from the print heads determines their position on the print medium 15. The timing may be adjusted based on the position of the inkjet printing assembly 7 along the first guide beam 6. The above-mentioned sensor 8 may therein be applied to determine the relative position and/or velocity of the inkjet printing assembly 7 with respect to the print medium 15. Based upon data from the sensor 8, the release timing of the marking material may be adjusted.

Upon ejection of the marking material, some marking material may be spilled and stay on a nozzle surface of the print heads. The marking material present on the nozzle surface may negatively influence the ejection of droplets and the placement of these droplets on the print medium 15. Therefore, it may be advantageous to remove excess of marking material from the nozzle surface. The excess of marking material may be removed, for example, by wiping with a wiper and/or by application of a suitable anti-wetting property of the surface, e.g. provided by a coating.

The marking materials may require treatment to properly fixate them on the print medium. Thereto, a fixation unit 10 is provided downstream of the inkjet printing assembly 7. The fixation unit 10 can emit heat and/or radiation to facilitate the marking material fixation process. In the example of FIG. 1, the fixation unit 10 is a radiation emitter that emits light of certain frequencies, which interacts with the marking materials, for example UV light in case of UV-curable inks. The fixation unit 10 in FIG. 1 is translatable along a second guide beam 9. Other fixation units 10, such as page-wide curing or drying stations may also be applied. Further, the inkjet printing assembly 7 may be provided with a further fixation unit on the same carriage that holds the print heads. This further fixation unit can be used to (partially) cure and/or harden the marking materials, independent of or interaction with the fixation unit 10.

After printing, and optionally fixation, the print medium 15 is transported to a receiving unit (not shown). The receiving unit may include a take-up roller for winding up the print medium 15, a receiving tray for supporting sheets of print medium 15, or a rigid media handler, similar to the media input unit 14. Optionally, the receiving unit may include processing means for processing the medium 15 after printing, e.g. a post-treatment device such as a coater, a folder, a cutter, or a puncher.

The wide-format printer 1 furthermore includes a user interface 11 for receiving print jobs and optionally for manipulating print jobs. The local user interface unit 11 is integrated to the print engine and may include a display unit and a control panel. Alternatively, the control panel may be integrated in the display unit, for example in the form of a touch-screen control panel. The local user interface unit 11 is connected to a control unit 12 connected to the printer 1. The control unit 12, for example a computer, includes a processor configured to issue commands to the printer 1, for controlling the print process, for example. The printer 1 may optionally be connected to a network. The connection to the network can be via cable or wireless. The printer 1 may receive printing jobs via the network. Further, optionally, the control unit 12 of the printer 1 may be provided with an input port, such as a USB port, so printing jobs may be sent to the printer 1 via this input port.

### Hybrid Printing System

The printer 1 in FIG. 1 is a so-called hybrid printer, capable of handling both flexible media and rigid substrates. In FIG. 1, the printer 1 operates in a first print mode, wherein the printer 1 is configured for transporting rigid substrates, such as the print medium 15. Such rigid print media 15 may be panels for doors, walls, etc., corrugated media, plates formed of plastic or metal, etc. To handle these rigid print media 15, the printer 1 in FIG. 1 is configured with a substantially linear transport path: from the media input device 14, the print medium 15 moves forward along the inkjet printing assembly 7 at a substantially constant height. The media input unit 14 and the receiving unit are positioned at the level of the medium support surface of the belt 4. In FIG. 2, a flexible web medium 16 is supplied to the printer 1, which web medium 16 may be composed of e.g. paper, label stock, coated paper, plastic or textile. The web medium 16 is supplied from the input roller 2A and extends across the belt 4 to the take-up roller 2B, where the web medium 16 is re-wound. The printer 1 is configured to swiftly and efficiently switch between print modes.

### Media Loading

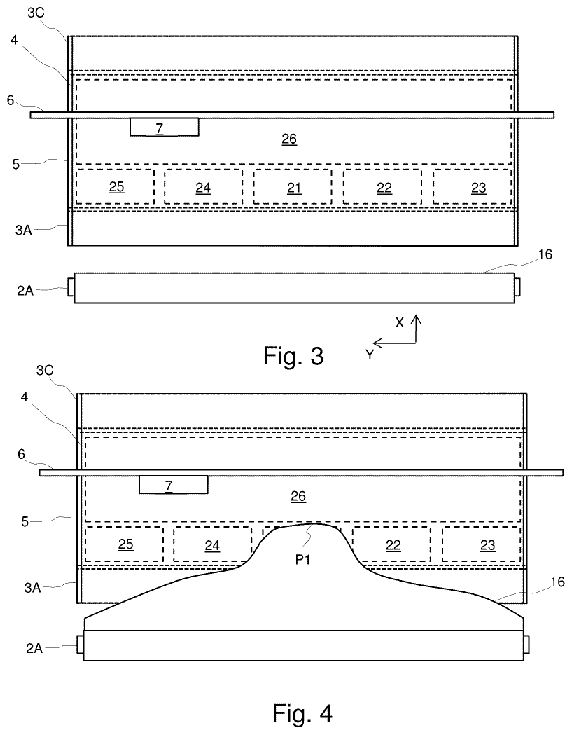

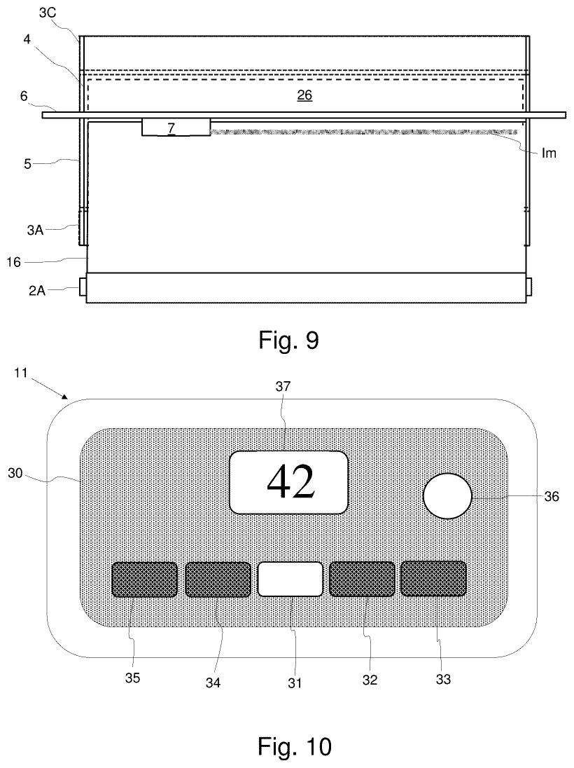

FIGS. 3 to 9 relate to the hybrid printer 1 operating in the roll-to-roll print mode as illustrated in FIG. 2. To begin printing on a new web of print medium 16, the web 16 is provided in roll form on the input roller 2A. The leading edge of the web 16 is then brought up to the belt 4 using the method illustrated in FIGS. 3 to 9. FIG. 3 illustrates the configuration of the suction box 5, which includes a plurality of suction chambers 21-25. The suction chambers 21-25 are substantially separated and/or isolated from each other, so that a negative pressure can be applied to any of the suction chambers 21-25 substantially independent from the other. For example, each suction chamber 21-25 is connected to a suction source (not shown), such as a fan or pump. The connection between each suction chamber 21-25 and its respective suction source can be selectively opened and closed by e.g. a valve. It will be appreciated that in one embodiment, multiple or all suction chambers 21-25 are connected to a common suction source. The suction chambers 21-25 are positioned in a row in the width direction Y. The row is positioned near the upstream support roller 3A, so that the suction chambers 21-25 are positioned near or at the area of the belt 4, where a new web 16 is loaded. In the transport direction X, the suction chambers 21-25 are positioned on the upstream side of the suction box 5, near the upstream support roller 3A. The suction chambers 31-25 preferably extend along the substantially full width of the print area of the printer 1.

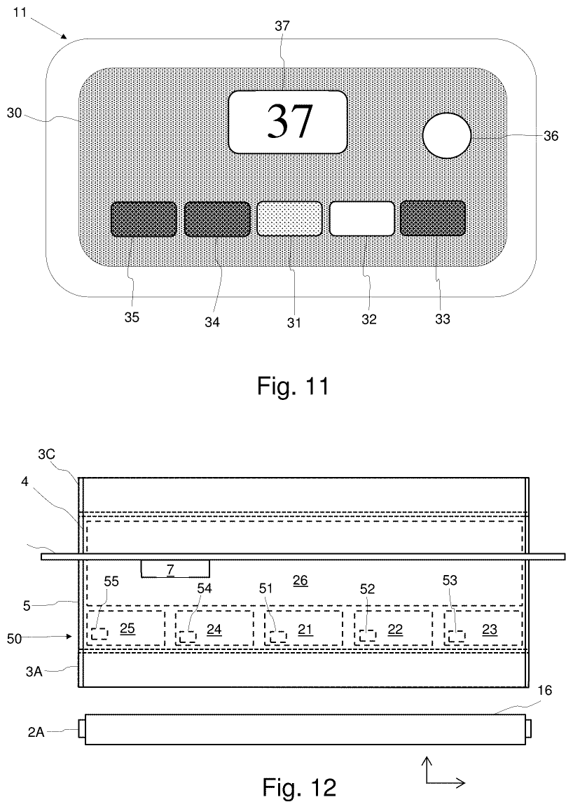

FIG. 3 shows the web 16 in its initial position on the input roller 2A. The suction chambers 21-25 are all not in fluid connection to suction source, so that the suction chambers 21-25 are all at atmospheric pressure. To load a new print medium 16, a first suction chamber 21-25 is selected for applying a negative pressure thereto. The selection may be done by an operator on the user interface 11 or via the printer's controller via a predetermined algorithm. FIG. 10 illustrates the user interface 11 used for selecting a suction chamber 21-25. The user interface 11 when operating in a web loading mode shows on its display 30 a plurality of suction chamber indicators 31-35, each corresponding to a respective suction chamber 21-25, for example by their positioning or by numbering. In the example in FIGS. 10-11, the left suction chamber indicator 31 corresponds to the left suction chamber 21, etc. When a negative pressure is applied to or removed from a respective suction chamber indicator 31-35, the respective suction chamber indicator 31-35 then changes to indicate that the pressure presently applied to said suction chamber 21-25, for example by changing its appearance, color, and/or shape. In the example in FIG. 10, the controller selects the respective suction chamber 21-25 and automatically applies a negative pressure thereto in combination with indicating this in the user interface 11. Additionally, upon applying a negative pressure to a suction chamber 21-25, the user interface 11 starts displaying a count down timer 37, which indicates a time remaining before the controller will connect a further suction chamber 21-25 to a suction source. In the example in FIG. 10, the countdown timer 37 counts down a predetermined number of seconds in which the operator can perform the step illustrated in FIG. 4. Preferably, the operator is able to set and/or change the time for the countdown timer 37 and the order for activating the suction chambers 21-25.

FIG. 4 illustrates the step of bringing a first portion P1 of the web 16 up to the selected first suction chamber 23 in the vertical direction Z. In this example, the central suction chamber 21 has been selected as the first suction chamber 23 to apply a negative pressure thereto. A central or middle portion of the web P1 near its leading edge corresponds to this suction chamber 21, as their positions in the width direction Y overlap. After the negative pressure has been applied to the first suction chamber 21, the user interface 11 indicates this in the first suction chamber indicator 31. The first portion P1 of the web 16 is then brought up from the input roller 2A up to the portion of the belt 4 over the first suction chamber 21. When the first portion P1 substantially covers the first suction chamber 21, the negative pressure will hold the first portion P1 in place on the belt 4. Until specifically indicated, a negative pressure will be applied to the first suction chamber 21. When the first portion P1 has been adhered to the belt 4 over the suction first chamber 21, a further suction chamber 22 is controlled for applying a negative pressure.

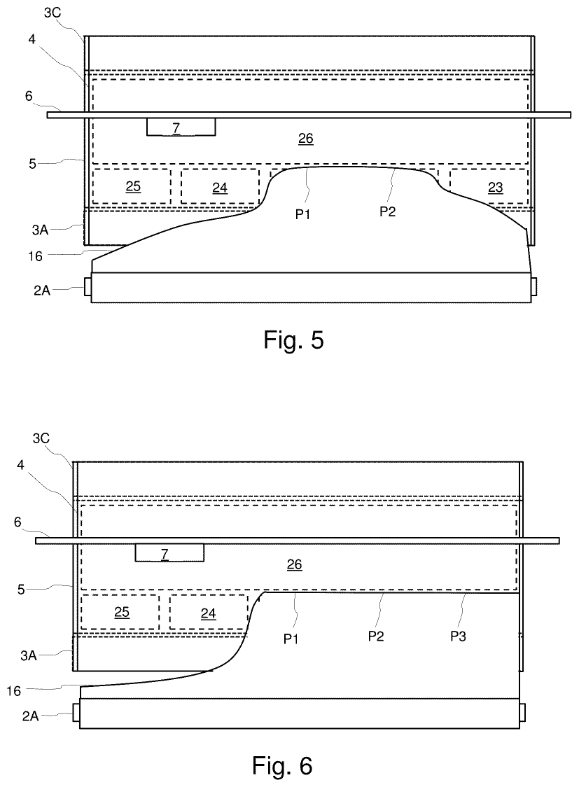

FIG. 11 illustrates selecting a further suction chamber 22 after a first portion of the web 16 has been adhered to the belt 4. In this example, the predetermined time set by the countdown timer 37 has expired, upon which the controller selects a further suction chamber 22 for applying a negative pressure thereto. The further suction chamber 22 is adjacent or neighboring a suction chamber 21 to which a negative pressure is already applied. In this example, the second suction chamber 22 is the right, direct neighbor of the first suction chamber 21, which is currently holding up the first portion of the web 16. In the example in FIG. 11, the continued, negative pressure in the first suction chamber 21 is indicated by a correspondingly altered appearance of the central suction chamber indicator 31. In addition, the controller connects the second suction chamber 22 to a suction source and indicates this by changing the appearance of the corresponding second suction chamber indicator 32. In addition, the countdown timer 37 is re-started. This indicates to the operator that a second portion P2 of the web 16 can brought up to and over the second chamber 22, so that two neighboring portions of the web 16 are then adhered onto the belt 4 on the input side of the printer 1. This is illustrated in FIG. 5

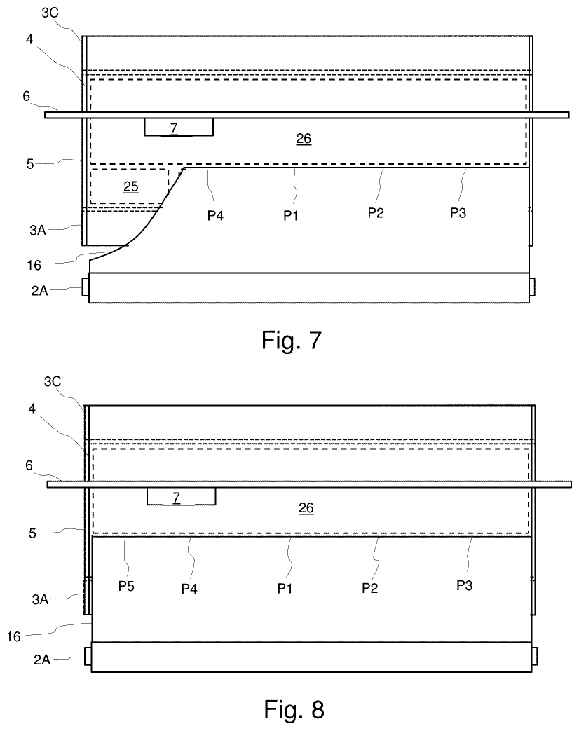

The above steps are repeated for the remaining suction chambers 23-25, so that each time a corresponding portion 33-35 of the web 16 is adhered onto the belt 4. FIG. 6 illustrates the portion P3 being adhered to the right most suction chamber 23, so that substantially the right half of the leading portion of the web 16 is held up by the corresponding suction chambers 21-23. In the next steps in FIG. 7, the left side neighbor of the first suction chamber 21, namely the fourth suction chamber 24, is selected and provided with a negative pressure, so that a fourth portion of the web 16 can be adhered to the belt 4. Then, in FIG. 8, the last suction chamber 25 on the left is selected and its pressure reduced. This allows the operator to adhere the left most portion P5 of the web 16 to the belt 4. Thereby, the leading portion of the web 16 is held by the suction chambers 21-25 onto the belt 4 along substantially its full width.

With the web 16 held along its substantially full width, the controller proceeds to drive the belt 4. Since the web 16 is held onto the belt 4 by the negative pressures, the leading portion of the web 16 moves with the belt 4 towards the guide beam 6. Below the printing area, the suction box 5 includes a printing suction chamber 26, which is downstream of the suction chambers 21-25. Thereby, the web 16 is brought into the printing area of the printing assembly 7. This allows the printing assembly 7 to begin the swath-wise printing of an image Im on the web 16. When a predetermined portion of the printing suction chamber 26 has been covered by the web 16, the controller may proceed to disconnect the suction chambers 21-25 from the suction source(s). The suction chambers 21-25 may also continue to provide a negative pressure to the web 16 during printing. The suction chambers 21-25 are then returned to atmospheric when the printing has been completed and for example a new web is to be loaded onto the input roller. The above-mentioned steps may then be repeated to load the new web.

The above-described steps allow a single operator to single handedly load a wide format web. Such webs may be at least 2 meters, even at least 2.5 meters, and sometimes more than 3 meters wide. The different suction chambers 21-25 in addition allow for so-called multi-lane printing, wherein multiple, individual substrates can be transported in parallel on the belt 4, when the printer operates in the rigid transport mode shown in FIG. 1. In the above-described example, the controller selects the suction chambers 21-25 to which a negative pressure is applied and indicates this to the operator on the user interface. This allows the operator to remain at the input roller 2A, as he does not need to input anything on the user interface 11. In another embodiment, the suction chamber indicators 31-35 may be configured as buttons, where the operator manually selects a suction chamber 21-25 by pressing the corresponding suction chamber indicators 31-35 on the user interface 11. Pressing said button activates or de-activates the negative pressure in the corresponding suction chamber 21-25 and preferably changes the appearance of the suction chamber indicators 31-35. Such buttons may also be used in addition to the countdown timer to allow the operator to proceed to loading the next portion before the timer has reached zero. Additional buttons, such as the belt drive button 36 for starting or stopping the motor driving the belt 4, may further be provided on the user interface 11. It will further be appreciated that while in the above examples a single suction chamber 21-25 is selected per step for applying a negative pressure thereto, multiple adjacent or neighboring suction chambers 21-25 may be selected at the same time, for example in case of an even, total number of suction chambers 21-25, the two central suction chambers 21-25 may be selected at once. Additionally, the order of selecting suction chambers 21-25 may be varied, in accordance with the preferences of the operator and/or requirements of the print medium 16. For example, the first selected suction chamber 21-25 may be any (or even multiple ones) of the suction chambers 21-25. Further selected suction chambers 21-25 are preferably neighbors of a previously selected suction chamber 21-25. Dependent on the width of the web 16 only a subset of the available suction chambers 21-25 may be used as well. For example, in case of tandem printing on two parallel rolls at the same time, only the suction chambers being overlapping by the print medium on the roll to be loaded may be utilized. The negative pressures are preferably similar for all suction chambers 21-25 by connecting them to a single suction source. During the process, the negative pressure in each suction chamber 21-25 may vary due to coverage of the suction chambers 21-25 and/or air permeability of the web 16. Different pressures may also be applied to different suction chambers 21-25 and/or for different print media 16.

FIG. 12 illustrates another embodiment of the printer in FIGS. 1 and 2. All components are similar to those in FIG. 3 and provided with the same reference numbers. The embodiment in FIG. 12 further includes a web placement detector array 50, wherein each suction chamber 21-25 is provided with its respective web placement detector 51-55. Each web placement detector 51-55 allows the controller to determine whether a respective suction chamber 21-25 has been at least partially covered with its respective portion P1-P5 of the web 16. Thereto, the web placement detector can 51-55 detect the pressure inside or the air flow through its suction chamber 21-25. For example, when it has been determined that the signal from a web placement detector 51-55 has reached or passed a predetermined value or has stabilized to a certain degree, the controller determines that the respective portion P1-P5 of the web 16 is in place over the suction chamber 21-25. Alternatively, the web placement detector 51-55 may include an optical detector, such as a camera or photodiode to detect whether the portion P1-P5 is in place.

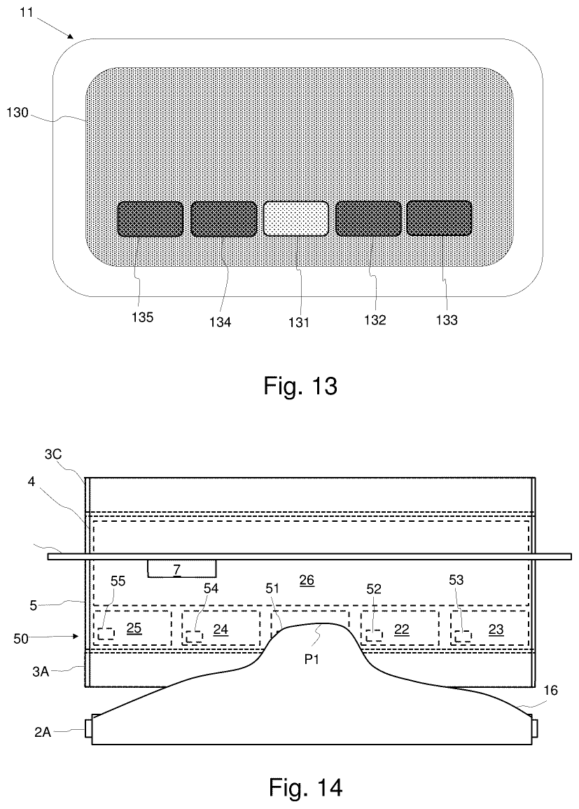

FIG. 13 illustrates the user interface belonging to the embodiment in FIG. 12. In the initial step, the controller selects a first suction chamber 21 to apply negative pressure to. This is indicated on the user interface by prompting the respective first suction chamber indicator 131, which corresponds to the first suction chamber 21. This indicates to the operator that the first portion P1 of the web 16 is to be loaded over the first suction chamber 21, as shown in FIG. 14.

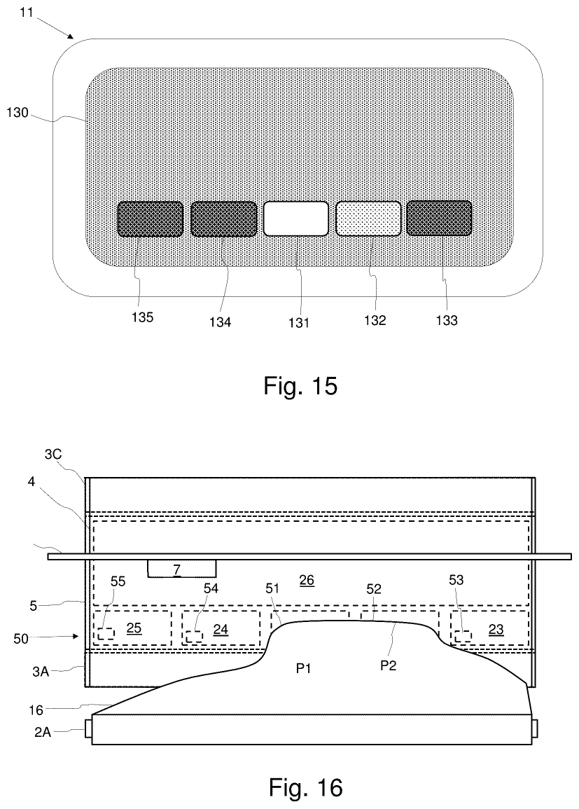

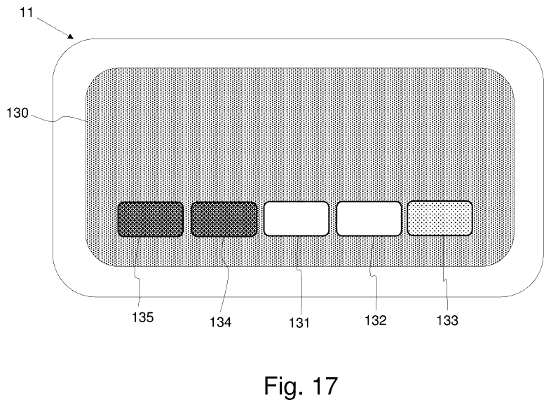

In FIG. 14, the first portion P1 of the web 16 covers the majority of the first suction chamber 21. This results in a decrease in pressure and/or reduced air flow in said first suction chamber 21. This is detected by the first web placement detector 51 in the first suction chamber 21. When the controller determines from the web placement detector 51 that the first portion of the web 16 is in place over the first suction chamber 21, it triggers the user interface to change the first suction chamber indicator 131, as shown in FIG. 15, to reflect this held state of the first portion P1. As the controller has determined that the first portion P1 is held onto the first suction chamber 21, it can now select a second suction chamber 22 to apply negative pressure to. Accordingly, the user interface 11 changes the second suction chamber indicator 132 to reflect that a negative pressure is applied there, as shown in FIG. 15.

The operator thus knows to load the second portion P2 of the web 16 over the second suction chamber 22. The presence of the second portion P2 there is detected by means of the second web placement detector 52. This detection informs the controller that the second portion P2 is also held in place over the second suction chamber 22. The operator can then proceed to load the third portion P3 of the web 16, as prompted by the third suction chamber indicator 133, which instructs the operator that a negative pressure has been applied to the third suction chamber 23.

Although specific embodiments of the disclosure are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present disclosure being thus described, it will be obvious that the same may be varied in many ways. Such variations are not to be regarded as a departure from the spirit and scope of the present disclosure, and all such modifications as would be obvious to one skilled in the art are intended to be included within the scope of the following claims.

1. A method of loading a web of print medium in a roll printer, wherein printer includes an endless transport belt extending over a plurality of independently controllable suction chambers positioned besides one another in a width direction of the belt and provided on an upstream side of the belt, wherein the width direction is perpendicular to a transport direction of the belt, the method comprising:
applying a negative pressure to a selected one of the suction chambers;
placing a portion of the web over the selected suction chamber, so that the portion is held in place on the belt by the negative pressure in the selected suction chamber;
repeating the previous steps for positioning remaining portions of the web over respective other suction chambers; and
driving the belt so that the web moves with the belt in the transport direction.

2. The method according to claim 1, wherein the step of placing follows the step of applying the negative pressure for each selected suction chamber.

3. The method according to claim 2, wherein the steps are repeated, so that the web becomes held by the respective suction chambers over its substantially full width.

4. The method according to claim 3, wherein the step of repeating is performed such that each suction chamber is consecutively provided with a respective portion of the web.

5. The method according to claim 1, wherein substantially no negative pressure is applied to suction chambers not covered by a respective portion of the web until a suction chamber has been selected for positioning a respective portion of the web.

6. The method according to claim 5, wherein initially substantially no negative pressure is applied to any of the suction chambers, and further comprising applying a negative pressure to a suction chamber different from the suction chamber over which previously a portion of the web has been positioned.

7. A wide format roll printer comprising:
an input roller;
an endless transport belt supported on a plurality of support rollers and defining a medium support area positioned above the input roller during use, wherein the plurality of support rollers includes an upstream support roller positioned on the side of the belt near the input roller;
a plurality of suction chambers positioned adjacent to the upstream support roller and provided besides one another in a width direction perpendicular to a transport direction of the belt;
a user interface configured for consecutively selecting and indicating each one of the suction chambers for applying a negative pressure to the selected suction chambers, such that a portion of the web can be adhered to the belt at the selected suction chambers.

8. The printer according to claim 7, wherein the user interface is configured to initiate driving the belt for moving the web held onto the belt, so that the web moves with the belt.

9. The printer according to claim 8, further comprising a controller configured to:
when operating in a multi-lane printing mode, control the transport belt to transport multiple individual substrates parallel to one another on the belt, wherein the controller controls to apply a negative pressure to the suction chambers in correspondence to the coverage of substrates over the suction chambers; and
when operating in a roll printing mode, configure the user interface for selecting and indicating each one of the suction chambers for loading a new web.
